(19) United States
(12) Patent Application Publication
(10) Pub. No.: US 2012/0266430 A1
(43) Pub. Date: Oct. 25, 2012

(54) Cooler repair kit

(76) Inventor: Fred B. Richardson, III, Pearl River, LA (US)

(21) Appl. No.: 13/066,578

(22) Filed: Apr. 19, 2011

(51) Int. Cl. B23P 6/00; B23P 19/04

(52) U.S. Cl. 29/402.02; 29/402.09; 29/402.17; 29/700

(57) ABSTRACT

A repair kit for molded plastic ice chests uses flexible foldable polyamide webbing band as a replacement hinge and loop handles. A set of attachment screws secures the band and the loop handles to the ice chest. Front closure members can be formed from the same polyamide webbing band and secured using screws to the front edge of the lid and the main part of the ice chest. Patches with matching hook-and-loop fasteners are secured to the overlapping front closure members.

### BACKGROUND OF THE INVENTION

This invention generally relates to coolers, such as insulated, portable, molded coolers with insulated walls, bottom and top, or to insulated containers having a removable top. More particularly, this invention relates to a repair kit for replacing carrying and closing elements for such coolers or containers. Still more particularly, this invention relates to easily securable handles and hinges for a molded or insulated containers.

Ice chests or cooler chests are available in many sizes, colors and styles. Though the exterior of the chests may vary in material, most of the working parts—hinges, straps, handles, closures and drain plugs—are conventionally made of plastic. After several years of use, these parts will break or tear. All of a cooler's components must be in good working order to contain the desired cold temperature inside the ice chest. Most manufacturers offer replacement parts that can extend the life of your cooler.

Some manufacturers sell plastic replacement hinges, drain plugs and screws for securing new hinges to the ice chest. Other manufacturers offer stainless steel hinges, wooden or plastic handles that can be attached to the cooler using screws. However, all manufacturers provide model-specific replacement parts, which are sized to fit only a single model of the ice chest. Many well-known cooler manufacturers insist that the replacement parts are intended for use only on specific products. Any other use of the replacement parts is prohibited as it may cause poor product performance and can cause serious personal injury and property damage.

The present invention contemplates elimination of drawbacks associated with conventional cooler repair kits and provision of a universal kit that can be used with various types and models of the ice chests available on the market.

It is, therefore, an object of the present invention to provide a cooler repair kit that is easy to use and inexpensive to manufacture.

It is another object of the invention to provide a cooler repair kit that can be used for repairing different types of ice chests.

It is a further object of the invention to provide a cooler repair kit that can be used for repairing many models and types of coolers.

These and other objects of the invention are achieved through a provision of a repair kit for molded plastic ice chests that uses flexible foldable polyamide webbing band as a replacement hinge and loop handles. A set of attachment screws secures the band and the loop handles to the ice chest. Front closure members can be formed from the same polyamide webbing band and secured using screws to the front edge of the lid and the main part of the ice chest. Patches with matching hook-and-loop fasteners are secured to the overlapping front closure members.

### BRIEF DESCRIPTION OF THE DRAWINGS

Reference will now be made to the drawings, wherein like parts are designated by like numerals, and wherein

FIG. 1 is a perspective view of the cooler repair kit according to the present invention.

FIG. 2 is a perspective view showing position of the flexible band in the hinge area of an ice chest.

FIG. 3 is a perspective view showing position of flexible hinge plates in the hinge area of an ice chest.

FIG. 4 is a detail view illustrating position of handles on a side wall of the ice chest.

FIG. 5 is a perspective view showing position of flexible closure plates in the front of an ice chest.

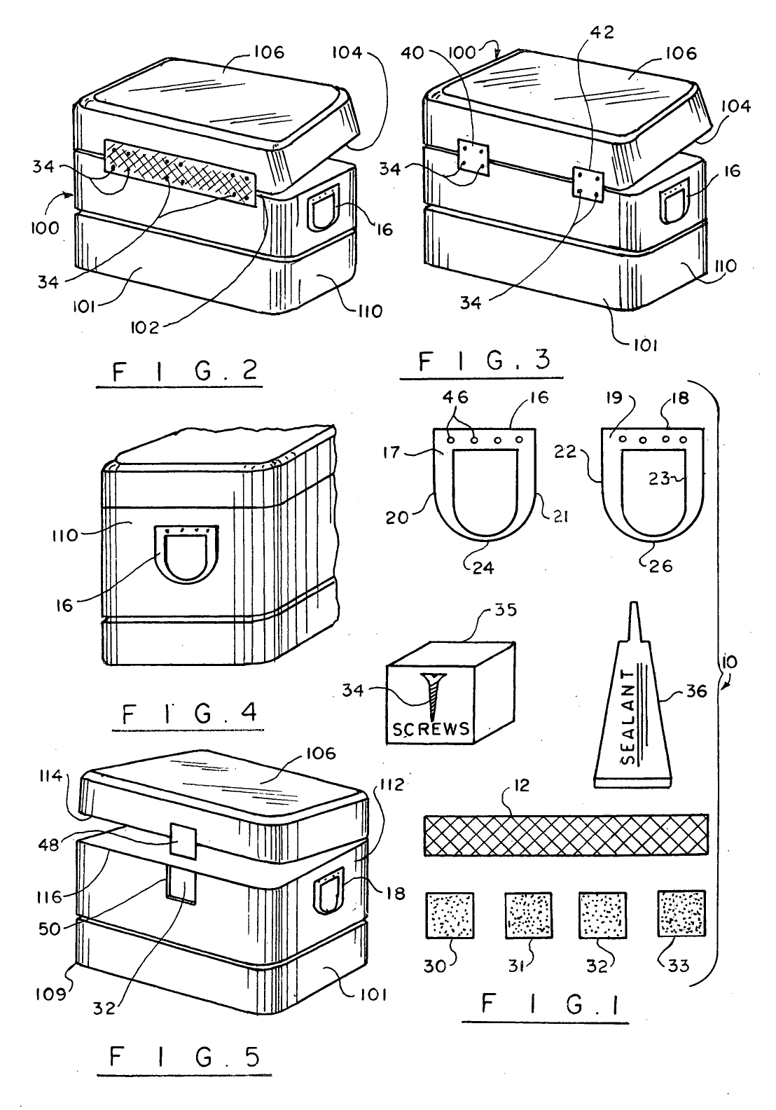

### DETAIL DESCRIPTION OF THE INVENTION

Turning now to the drawings in more detail, numeral 10 designates the cooler repair kit according to the present invention. The repair kit comprises a pre-determined length of a flexible band 12 made from a strong foldable material, such as for instance polyamide webbing. The specific material may be nylon, polypropylene or polyester flat webbing having about 0.9″ in thickness and about 2″ in width with high breaking strength characteristics. The band 12 can be between 20 and 36″ long, as desired.

The kit 10 further comprises handles 16 and 18, which can be made from the same webbing material as the band 12. It should be understood that the handles 16 and 18 are flexible and deformable, similarly to the band 12. Each handle 16 and 18 is formed as a loop with ends of an elongated band stitched together. The handles have an attachment portion 17, 19, respectively, which are unitary connected to side portions 20, 21 and 22, 23.

The handles 16, 18 have gripping portions 24 and 26, respectively. In one of the preferred embodiments, the gripping portions are formed by folding the webbing width in half lengthwise and stitching the folded halves together. The gripping portions 24 and 26 can be 5-10″ long to accommodate user with large hands and make it comfortable for the users to carry a molded ice chest 100.

The cooler repair kit 10 also comprises a set of patches 30, 31, 32, and 33, which can be square, rectangular or of any other desired configuration. The patches 30 and 31 have hook fasteners, while the patches 32 and 33 have matching loop fasteners secured on one of their surfaces. Depending on the number of front closures, as will be described in more detail hereinafter, two or four patches are used.

The cooler repair kit 10 also comprises a set of attachment members, such as screws 34 stored in a box 35. The screws 34 have different lengths to allow the band 12 to be secured to the ice chest 100 regardless of how thick the wall of the ice chest 100 may be. The screws can be flat-head screws or Phillips-head screws. The cooler repair kit 10 further comprises a pre-determined quantity of a sealant stored on a container 36. The sealant is an adhesive suitable for attaching the patches 30-33 to the webbing band 12 and for sealing openings formed by the screws 34 in the walls of the ice chest 100.

Depending on the repairs desired for the ice chest 100 all or several members of the kit 10 can be used. If the hinge of the ice chest is broken, the user has two options when repairing the hinge with the band 12. The user can remove the broken hinge in its entirety. Conventionally, the cooler chest 100 has a main part 101 and a lid 106. According to one choice, the user cuts the required length from the band 12 and secures one elongated edge of the band 12 to an upper edge 102 of the main part 101 using the screws 34, as shown in FIG. 2. The opposite elongated edge of the band 12 is secured with the screws 34 to a lower edge 104 of the lid 106, while the lid 106 is aligned with the main part 101.

According to the second choice, the user cuts two webbing pieces 40, 42 from the length of the webbing band 12. The webbing pieces can be square or rectangular. The user then attaches the webbing pieces 40, 42 in a spaced-apart relationship, as shown in FIG. 3. One edge of the webbing pieces 40, 42 is secured to the upper edge 102 of the main part 101 of the cooler chest 100, while the opposite edge is secured to the lower edge 104 of the lid 106 using the screws 34. Since the webbing band 12 is flexible and foldable, the band 12 and the webbing pieces 40, 42 create a readily foldable hinge between the main part 101 and the lid 106.

If the handles of the cooler chest 100 are broken, the user can attach one or two handles 16 and 18 to the sidewalls 110, 112 of the cooler chest 100. The user secures the attachment portions 17, 19 of the handles 16, 18 to the sidewalls 110, 112 using the screws 34. If desired, the attachment portions 17 and 19 can be provided with pre-formed openings 46 to make it easier for the user to attach the replacement handles 16, 18 to the sidewalls 110, 112. If desired the openings 46 can be protected by grommets to prevent the webbing band 12 from unraveling.

If the front closure of the ice chest 100 is broken the user can cut two or multiples of two pieces of webbing band 12 and form front closure members 48 and 50. The first front closure member 48 is secured with screws 34 to the lower front edge 114 of the lid 106, while the second front closure member 50 is secured to the front upper edge of the main part 101 using screws 34, as shown in FIG. 5. The front closure members 48 and 50 partially overlap and have contacting surfaces.

One of the patches 30 or 31 is secured using adhesive 36, to an interior contacting surface of the webbing piece 48, while a patch 32 or 33 is secured, using adhesive 36, to the outer contacting surface of the webbing piece 50. When the lid 106 is closed, the patches 30 and 32 are aligned and are secured together using the hook-and-loop fasteners.

Alternatively, the user can cut four webbing pieces and secure them in opposing pairs in a spaced apart relationship to the front edge 116 of the main part 101 and the front lower edge 114 of the lid 106. In such a case, the patches 30, 31 can be secured to the webbing pieces on the main part 101 and the patches 32, 33 can be secured to the webbing pieces on the lid 106. The lid 106 can then be closed using two closure units.

If desired, the sealant 36 can be used for sealing the opening formed by the screws 34 inserted into the walls of the ice chest 100. The same sealant can protect the integrity of the webbing band 12 in locations where the screws 34 make holes during attachment to the ice chest 100.

The repair kit of the present invention provides easy to attach replacement parts for any type of molded plastic coolers. As described above, the replacement hinges, closures and handles can be secured to the plastic ice chests and thereby extend the lifetime of the cooler chests. The webbing band preferably has high breaking strength, capable of supporting the weight of hundreds of pounds of loaded chests.

Many changes and modifications can be made in the present invention without departing from the spirit thereof I, therefore, pray that my rights to the present invention be limited only by the scope of the appended claims.

I claim:

1. A repair kit for repairing a cooler chest, comprising:
a predetermined length of a flexible foldable flat webbing band, at least one flexible handle, a plurality of attachment members configured for securing the webbing band to the cooler chest, and a plurality of patches having hook-and-loop fasteners configured for attachment to selected portions of the webbing band when the selected portions of the webbing band are secured to the cooler chest.

2. The kit of claim 1, further comprising a sealant for attaching the patches having hook-and-loop fasteners to the selected portions of the webbing band.

3. The kit of claim 1, wherein said sealant comprises an adhesive material.

4. The kit of claim 1, wherein said at least one handle comprises a loop-shaped body.

5. The kit of claim 1, wherein the at least one handle comprises an attachment portion configured for attachment to the cooler chest and a gripping portion unitary connected to the attachment portion and configured for gripping by a user.

6. The kit of claim 5, wherein the at least one handle comprises a loop-shaped body formed from a flat webbing band, and wherein the gripping portion is formed by folding a selected part of the webbing band lengthwise in half and stitching the folded halves together.

7. The kit of claim 1, comprising a pair of flexible handles.

8. The kit of claim 1, wherein the attachment members comprise screws.

9. The kit of claim 1, wherein said webbing band comprises a polyamide webbing band.

10. A method of repairing a molded plastic cooler chest having a main part with an upper edge and a lid with a lower edge, the method comprising the steps:
providing at least one pre-determined length of a flexible foldable flat webbing band with opposing band edges;
providing a plurality of attachment members;
securing a first band edge of the webbing band to the upper edge of the main part with said attachment members; and
securing a second band edge of the webbing band to the lower edge of the lid with the attachment members, said webbing band folding along a hinge line while hingedly securing the lid to the main part.

11. The method of claim 10, wherein said step of providing at least one pre-determined length of a flexible foldable flat webbing band comprises a step of cutting four selected lengths of the webbing band and attaching said four selected lengths of the webbing band in spaced apart pairs to the upper edge of the main part and lower edge of the lid with said attachment members.

12. The method of claim 10, further comprising a step of providing a loop handle having an attachment portion and a gripping portion and securing the attachment portion to a sidewall of the cooler chest.

13. The method of claim 12, wherein said loop handle comprises a loop-shaped body formed from a flat webbing band, and wherein the gripping portion is formed by folding a selected part of the webbing band lengthwise in half and stitching the folded halves together.

14. The method of claim 10, wherein said attachment members comprises screws.

15. The method of claim 14, further comprising a step of providing a sealant and applying the sealant to the attachment members in areas of contact of the attachment members with the cooler chest.

16. The method of claim 10, further comprising a step forming a first front closure member and a second front closure member from a flexible flat webbing band and securing the first front closure member to a front lower edge of the lid and securing the second closure member to a front upper edge of the main part with said attachment members such that the first closure member and the second closure member partially overlap and have contacting surfaces.

17. The method of claim 16, further comprising a step of providing plurality of patches having hook-and-loop fasteners and securing the patches to the contacting surfaces of the first closure member and the second closure member.

18. The method of claim 17, further comprising a step of providing a sealant and securing the patches to the contacting surfaces of the first closure member and the second closure member.

19. The method of claim 18, wherein the sealant comprises an adhesive material.

20. The method of claim 10, wherein the webbing band comprises polyamide webbing band.
